(19) United States
(12) Patent Application Publication
(10) Pub. No.: US 2026/0313394 A1
(43) Pub. Date: Oct. 8, 2026

(54) METHOD AND APPARATUS FOR STOPPING WIRELESS ACCESS NETWORK-BASED NOTIFICATION AREA UPDATE FOR MOBILE INTEGRATED ACCESS AND BACKHAUL NODE IN WIRELESS COMMUNICATION SYSTEM

(71) Applicant: Samsung Electronics Co., Ltd., Gyeonggi-do (KR)

(72) Inventor: June HWANG, Gyeonggi-do (KR)

(21) Appl. No.: 19/484,599

(22) PCT Filed: May 9, 2024
(86) PCT No.: PCT/KR2024/006270

§ 371 Date: Nov. 14, 2025

(30) Foreign Application Priority Data
May 18, 2023 (KR) 10-2023-0064519

(51) Int. Cl. H04W 24/02; H04W 76/19; H04W 88/08

(52) U.S. Cl. CPC H04W 24/02; H04W 76/19; H04W 88/08

(57) ABSTRACT

The present disclosure relates to a 5G or 6G communication system for supporting higher data transmission rates. A control signal processing method in a wireless communication system, according to one embodiment of the present disclosure, comprises the steps of: receiving a first control signal transmitted from a base station; processing the received first control signal; and transmitting, to the base station, a second control signal generated on the basis of the processing.

### TECHNICAL FIELD

The disclosure relates to a method performed by a terminal in a mobile communication system and a device therefor. Specifically, the disclosure relates to radio access network (RAN)-based notification area (RNA) update of access terminals according to movement of a mobile IAB node.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience. NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the above and with the development of mobile communication systems enabling a variety of services, there is a growing demand for methods to deliver those services effectively.

### DISCLOSURE OF INVENTION

### Technical Problem

During migration of a distributed unit (DU) according to movement of a mobile IAB (mIAB) node, cell configuration and setting may be changed, and a RAN-based notification area code may also be changed at the same time. In this situation, if multiple inactive terminals concurrently perform a RAN-based notification area update (RNAU) procedure, communication may not be smoothly performed due to congestion occurring on radio resources.

### Solution to Problem

In order to solve the problem described above, a control signal processing method in a wireless communication system according to an embodiment of the disclosure may include: receiving a first control signal transmitted from a base station; processing the received first control signal; and transmitting a second control signal generated based on the processing to the base station.

### Advantageous Effects of Invention

A method and a device according to an embodiment of the disclosure may prevent radio access congestion due to RNAU of multiple UEs in an mIAB cell.

### BRIEF DESCRIPTION OF DRAWINGS

FIG. 1 illustrates a structure of an LTE system.

FIG. 2 illustrates a radio protocol structure of an LTE system.

FIG. 3 illustrates a structure of a wireless communication system.

FIG. 4 illustrates a radio protocol structure of a wireless communication system according to an embodiment of the disclosure.

FIG. 5 is a block diagram illustrating an internal structure of a UE according to an embodiment of the disclosure.

FIG. 6 is a block diagram illustrating a structure of an NR base station according to an embodiment of the disclosure.

FIG. 7 illustrates a process related to movement of an mIAB node.

FIG. 8 illustrates a process related to DU migration of an mIAB according to an embodiment of the disclosure.

FIG. 9 illustrates a process related to DU migration of an mIAB according to an embodiment of the disclosure.

FIG. 10 is a block diagram illustrating an example of a structure of a UE according to an embodiment of the disclosure.

FIG. 11 is a block diagram illustrating an example of a structure of a base station according to an embodiment of the disclosure.

### MODE FOR THE INVENTION

Hereinafter, the operation principle of the disclosure will be described in detail in conjunction with the accompanying drawings. In describing the disclosure below, a detailed description of relevant known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B. an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (or eNB or gNB), and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, e MBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC may have requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus. URLLC must provide communication with very low latency (ultra-low latency) and high reliability (ultra-high reliability). For example, a service supporting URLLC must satisfy an air interface latency of less than 0.5 ms, and may also require a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB. URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

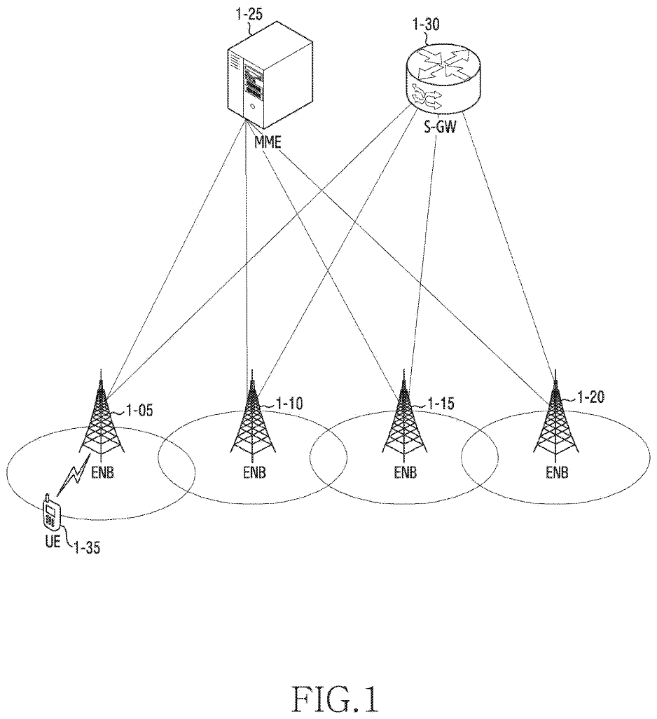

FIG. 1 illustrates a structure of an LTE system.

Referring to FIG. 1, as illustrated therein, a radio access network of an LTE system may include evolved Node Bs (ENBs) (may hereinafter be referred to as “Node Bs” or “base stations”) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may each correspond to a conventional node B in a UMTS system. The ENBs may be connected to the UE 1-35 through a radio channel, and perform more complicated roles than the conventional node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENNBs 1-05 to 1-20 may serve as the device. In general, one ENB may control multiple cells. For example, in order to implement a transfer rate of 100 Mbps, the LTE system may use orthogonal frequency division multiplexing (OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

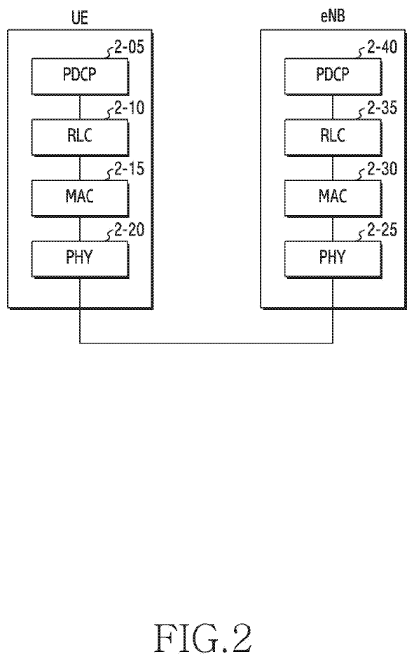

FIG. 2 illustrates a radio protocol structure of an LTE system.

Referring to FIG. 2, a radio protocol of an LTE system may include a packet data convergence protocol (PDCP) 2-05 or 2-40, a radio link control (RLC) 2-10 or 2-35, and a medium access control (MAC) 2-15 or 2-30 on each of UE and ENB sides. The PDCP may serve to perform operations such as IP header compression/reconstruction. The main functions of the PDCP may be summarized as follows.
Header compression and decompression: ROHC only
Transfer of user data
In-sequence delivery of upper layer protocol data units (PDUs) at PDCP re-establishment procedure for RLC acknowledged mode (AM)
For split bearers in DC (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 2-10 or 2-35 may reconfigure a PDCP protocol data unit (PDU) into an appropriate size to perform an ARQ operation. The main functions of the RLC may be summarized as follows.
Transfer of upper layer PDUs
Error Correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 may be connected to several RLC layer devices configured in a single terminal, and multiplex RLC PDUs into a MAC PDU and demultiplex a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

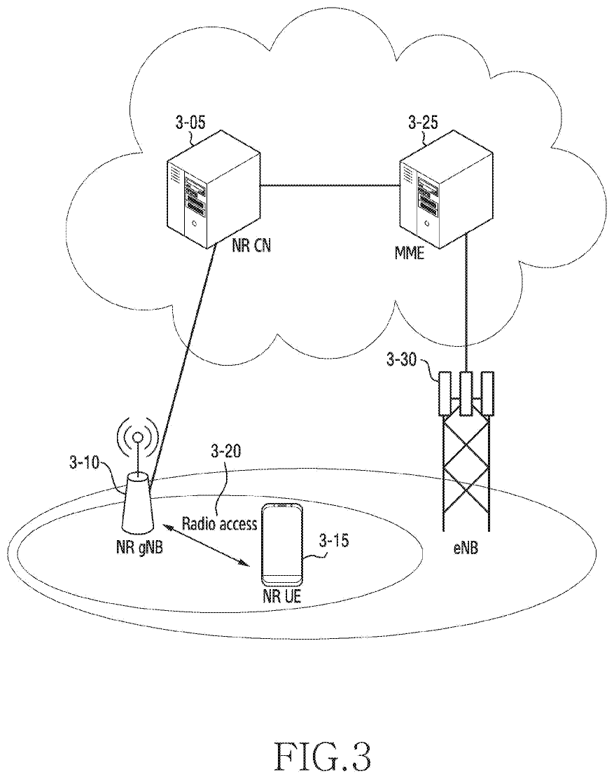

FIG. 3 illustrates a structure of a wireless communication system.

Referring to FIG. 3, a radio access network of a wireless communication system (may hereinafter be referred to as “NR or 5G system”) may include a new radio Node B (hereinafter NR gNB or NR base station) 3-10, and a new radio core network (NR CN) 3-05. A new radio user equipment (NR UE) (may hereinafter be referred to as “UE”) 3-15 may access an external network via the NR gNB 3-10 and the NR CN 3-05.

In FIG. 3, the NR gNB 3-10 may correspond to an evolved Node B (eNB) of a conventional LTE system. The NR gNB is connected to an NR UE 3-15 through a radio channel and may provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may serve as the device. In general, one NR gNB may control multiple cells.

In order to implement ultrahigh-speed data transfer beyond the current LTE, the next-generation mobile communication system may employ a wider bandwidth than the existing maximum bandwidth. In addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE.

The NR CN 3-05 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 3-25 via a network interface. The MME may be connected to an eNB 3-30 that is an LTE base station.

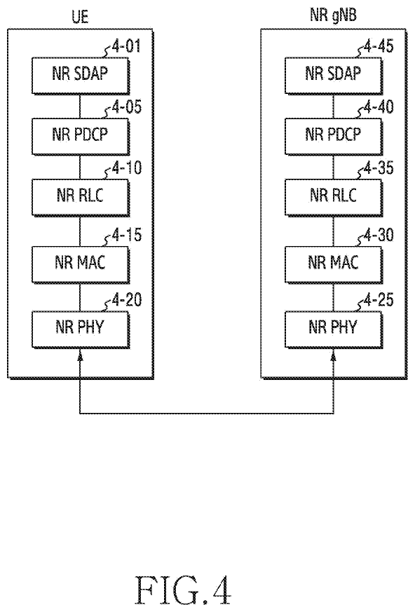

FIG. 4 illustrates a radio protocol structure of a wireless communication system according to an embodiment of the disclosure.

Referring to FIG. 4, a radio protocol of a next-generation mobile communication system may include an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 on each of UE and NR base station sides.

The main functions of the NR SDAP 4-01 or 4-45 may include some of functions below.
Transfer of user plane data
Mapping between a QoS flow and a DRB for both DL and UL
Marking QoS flow ID in both DL and UL packets
Reflective QoS flow to DRB mapping for the UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels.

If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 4-05 or 4-40 may include some of functions below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above-described functions, the reordering of the NR PDCP device may refer to a function of reordering PDCP PDU received from a lower layer in an order based on PDCP sequence numbers (SNs). The reordering of the NR PDCP device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

The main functions of the NR RLC 4-10 or 4-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device may refer to a function of, if there is a lost RLC PDU, delivering only RLC SDUs before the lost RLC PDU to the upper layer in sequence. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery function of the NR RLC device may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, and may include a function of requesting retransmission of lost RLC PDUs.

The in-sequence delivery of the NR RLC device may refer to a function of, if there is a lost RLC PDU, delivering only RLC SDUs before the lost RLC PDU to the upper layer in sequence.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to the current, to a higher layer.

The NR RLC device may process RLC PDUs in a reception sequence, regardless of a sequence based on sequence numbers (out-of-sequence delivery), and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may include no concatenation function, which may be performed in the NR MAC layer or replaced with a multiplexing function of the NR MAC layer.

Among the above-described functions, the out-of-sequence delivery of the NR RLC device may refer to a function of instantly delivering RLC SDUs received from the lower layer to the upper layer regardless of the order. The out-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging the order thereof to record lost RLC PDUs.

The NR MAC 14-15 or 4-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

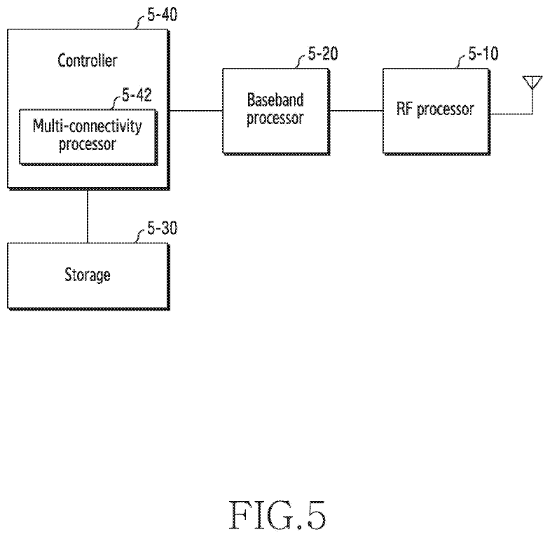

FIG. 5 is a block diagram illustrating a structure of a UE according to an embodiment of the disclosure.

Referring to the drawing, the UE may include a radio frequency (RF) processor 5-10, a baseband processor 5-20, a storage 5-30, and a controller 5-40.

The RF processor 5-10 may perform functions for transmitting/receiving signals through a radio channel, such as signal band conversion and amplification. The RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of signals transmitted/received through multiple antennas or antenna elements, respectively. In addition, the RF processor may perform MIMO, and may receive multiple layers when performing a MIMO operation.

The baseband processor 5-20 may perform functions of conversion between baseband signals and bitstnngs according to the physical layer specifications of the system. For example, during data transmission, the baseband processor 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the orthogonal frequency division multiplexing (OFDM) scheme, during data transmission, the baseband processor 5-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

The baseband processor 5-20 and the RF processor 5-10 may transmit and receive signals as described above. Therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2NRHz) bands and millimeter wave (mmWave) (e.g., 60 GHz) bands.

The storage 5-30 may store basic programs, application programs, and data, such as configuration information, for operation of the main base station. Particularly, the storage 5-30 may store information regarding a second access node configured to perform wireless communication by using a second radio access technology. In addition, the storage 5-30 may provide the stored data at the request of the controller 5-40.

The controller 5-40 controls the overall operation of the UE. For example, the controller 5-40 may transmit/receive signals through the baseband processor 5-20 and the RF processor 5-10. In addition, the controller 5-40 records data in the storage 5-30 and reads the data from the storage 5-30. To this end, the controller 5-40 may include at least one processor. For example, the controller 5-40 may include a communication processor (CP) configured to perform control for communication, and an application processor (AP) configured to control upper layers such as application programs. The controller 5-40 may include a multi-connectivity processor 5-42.

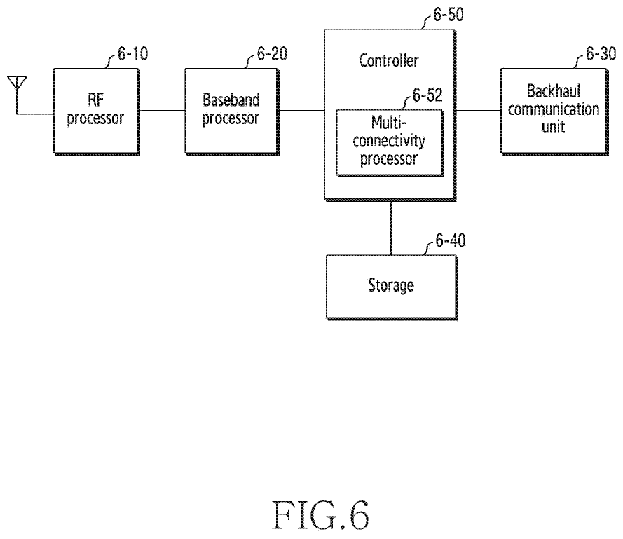

FIG. 6 is a block diagram illustrating a structure of an NR base station according to an embodiment of the disclosure.

As illustrated in the drawing, the base station may include an RF processor 6-10, a baseband processor 6-20, a backhaul communication unit 6-30, a storage 6-40, and a controller 6-50.

The RF processor 6-10 may perform functions for transmitting/receiving signals through a radio channel, such as signal band conversion and amplification. The RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in the drawing, the first access node may include multiple antennas. In addition, the RF processor 6-10 may include multiple RF chains. Furthermore, the RF processor 6-10 may perform beamforming. For the beamforming, the RF processor 6-10 may adjust the phase and magnitude of signals transmitted/received through multiple antennas or antenna elements, respectively. The RF processor may transmit one or more layers to perform a downward MIMO operation.

The baseband processor 6-20 may perform functions of conversion between baseband signals and bitstrings according to the physical layer specifications of first radio access technology. For example, during data transmission, the baseband processor 6-20 may encode and modulate a transmitted bitstring to generate complex symbols. In addition, during data reception, the baseband processor 6-20 may demodulate and decode a baseband signal provided from the RF processor 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through IFFT operation and CP insertion. In addition, during data reception, the baseband processor 6-20 may split a baseband signal provided from the RF processor 6-10 at the OFDM symbol level, may restore signals mapped to subcarriers through FFT operation, and may restore a received bitstring through demodulation and decoding. The baseband processor 6-20 and the RF processor 6-10 may transmit and receive signals as described above. Therefore, the baseband processor 6-20 and the RF processor 6-10 may be referred to as a transmitter, a receiver, a transceiver, or a communication unit.

The backhaul communication unit 6-30 provides an interface for communicating with other nodes in the network. The backhaul communication unit 6-30 converts bitstrings transmitted from the main base station to other nodes, for example, an auxiliary base station, a core network, etc., into physical signals, and converts physical signals received from the other nodes into bitstrings.

The storage 6-40 may store basic programs, application programs, and data, such as configuration information, for operation of the main base station. Particularly, the storage 6-40 may store information regarding a bearer allocated to a connected UE, a measurement result reported from the connected UE, and the like. In addition, the storage 6-40 may store information serving as criteria for determining whether to provide multi-connectivity to a UE or to suspend the same. In addition, the storage 6-40 may provide the stored data at the request of the controller 6-50.

The controller 6-50 controls the overall operation of the main base station. For example, the controller 6-50 transmits/receives signals through the baseband processor 6-20 and the RF processor 6-10 or through the backhaul communication unit 6-30. In addition, the controller 6-50 records data in the storage 6-40 and reads the data from the storage 6-40. To this end, the controller 6-50 may include at least one processor. The controller 6-50 may include a multi-connectivity processor 6-42.

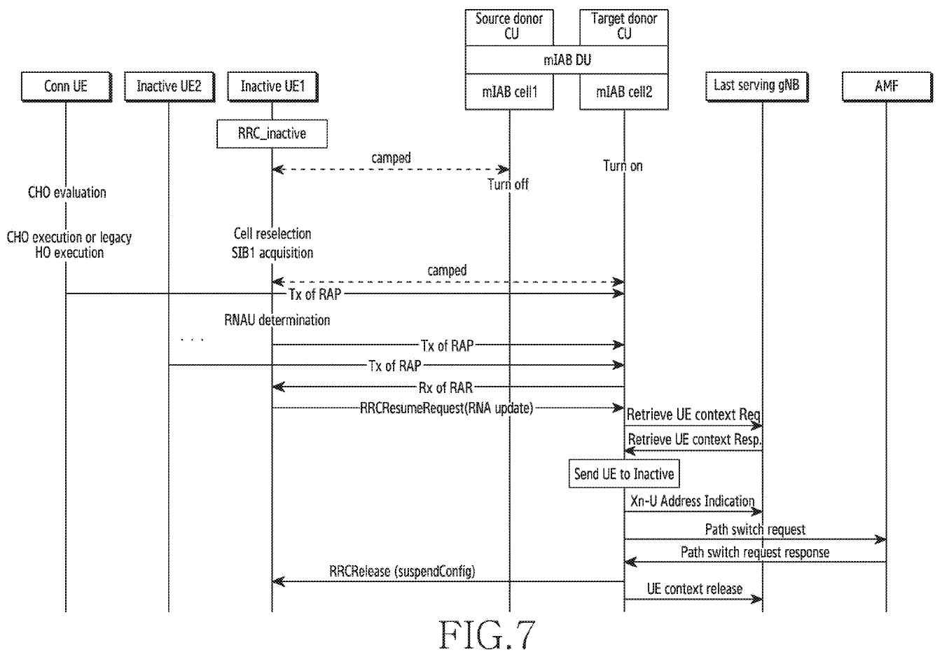

FIG. 7 illustrates a process related to movement of an mIAB node. Specifically, FIG. 7 is a flowchart illustrating a situation that may generally occur when an IAB node moves.

FIG. 7 is based on an assumption that inactive UE1, inactive UE2, and a connected UE (Conn UE) are camped on and RRC-connected to mIAB cell 1. In this case, the mIAB node may be connected to a source donor central unit (CU).

Thereafter, due to movement of the mIAB node, migration to a target donor CU may be performed, and during this procedure. mIAB cell 1 may be turned off, and mIAB cell 2 may be turned on. In this case, mIAB cell2 may transmit an SS/PBCH block (SSB) and system information to the UEs, based on a new NR cell global identifier (NCGI) and a physical cell identity (PCI). Accordingly, inactive UE 1 and inactive UE 2 may perform cell reselection based on mIAB cell 2, and the connected UE (Conn UE in FIG. 7) may perform conditional handover (CHO) to mIAB cell 2 according to a configuration in the existing cell (mIAB cell 1).

If a RAN-based notification area (RNA) of the target donor CU is different from an RNA of the source donor CU, and is not included in an RNA list that is previously configured for inactive UE1 or inactive UE2, then inactive UE1 or inactive UE2 needs to perform RAN update (RNAU). To this end, inactive UE1 or inactive UE2 may perform random access.

In this case, both UEs (e.g., active UE 1 and inactive UE 2 in FIG. 7) that have performed camping and cell reselection to mIAB cell2 and UEs configured with conditional handover among connected UEs may perform random access at relatively similar time points (for example, in FIG. 7, Tx of a random-access preamble (RAP) or Rx of a random-access request (RAR) may be performed within a short time period). Accordingly, congestion may occur in random-access time resources, and only a few UEs may successfully perform random access to a network. For example, in FIG. 7, only inactive UE1 obtains an UL grant to transmit an RRC message for RAN update.

In order to solve the aforementioned problem, an RNAU procedure itself in a UE can be simplified. However, without performing an RNAU procedure in a UE, a method for donor nodes to retrieve an inactive context of the UE according to a movement situation of an mIAB node is also possible.

Handover of a mobile termination (MT) and migration of a distributed unit (DU) due to movement of an mIAB node may be operated according to the following procedure.

An mIAB node may include an mIAB DU and an mIAB MT, and the MT may be connected to a cell of a parent IAB node and may exchange control plane (CP) data and user plane (UP) data. The DU may configure a cell for UEs that receive a service of the mIAB node, and may perform DL data transmission and UL data reception to and from the UEs. The DU may receive, from a donor node connected via the MT, DL data and UL data to be transmitted from the UEs, or transmit, to the donor node via the MT, DL data and UL data received from the UEs. The donor node may exchange DL data and UL data with a core network.

It is assumed that a wireless link of the MT is connected to a DU controlled by the donor node CU1 or to a donor DU controlled by CU1. In FIG. 7, the connection of the DU or the donor DU and the mIAB node is omitted, and a source donor CU (i.e., donor node CU1) or a target donor CU (i.e., donor node CU2) is directly expressed.

According to movement of the mIAB node, the MT connected to a cell of the DU or the donor DU controlled by existing donor node CU1 may switch its connection to a cell of a DU or a donor DU controlled by donor node CU2, due to performance deterioration of the wireless link. This may be expressed as a handover of the MT of the mIAB node. The handover may be performed in a manner similar to an existing handover of UE. After the handover of the MT is performed, the DU of the mIABnode may also change the donor node of the DU from CU1 to CU2. This procedure may be referred to as DU migration.

During the DU migration procedure, the DU may operate two logical DUs. A source logical DU is a DU that operates a cell associated with the source donor CU (i.e., CU1), and a target logical DU is a DU that operates a cell associated with the target donor CU (i.e., CU2). The cells operated by the respective DUs may be operated in the same time slot, and in this case, the cells are operated via different radio physical resources. That is, via different radio physical resources, signals of the cell of the source logical DU may be transmitted and/or received, and signals of the cell of the target logical DU may be transmitted and/or received.

During the DU migration procedure, after an F1 interface is set up between the target logical DU and CU2, i.e., the target donor CU of DU migration, and activated cell configuration information of the target logical DU is received from CU2, the mIAB DU starts operation of the cell of the target logical DU (i.e., mIAB cell 2 in FIG. 7). At this point, since the cell (e.g., cell 1 in FIG. 7) of the logical DU associated with existing CU1 is already in operation, and cell 2 is also in operation, there may exist a time period in which cell 1 and cell 2 simultaneously operate for a certain time after cell 2 starts operating (i.e., until cell 1 suspends operation).

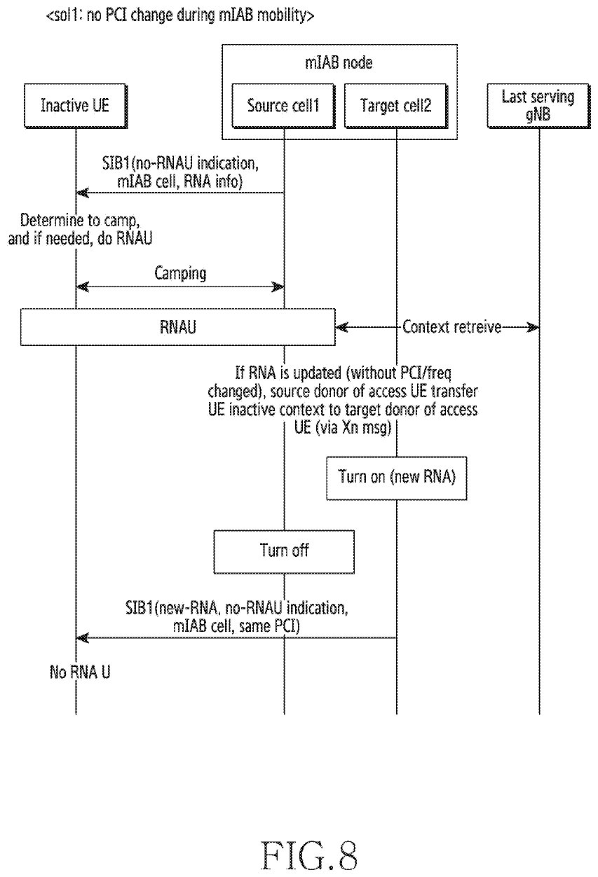

FIG. 8 illustrates a process related to DU migration of an mIAB according to an embodiment of the disclosure. Specifically. FIG. 8 illustrates a process of a case in which only an RNA is changed without a cell change during DU migration of an mIAB.

FIG. 8 illustrates a case in which, during DU migration of an mIAB node, a donor CU is changed, and while a PCI and a cell frequency are the same as those of a cell configured by an existing source donor CU, an RNA is changed. A UE that has camped on a previous stationary cell may camp on a source logical DU cell of a DU of the mIAB node.

In this procedure, the UE performs cell reselection, selects the source logical DU cell of the mIAB node by considering a wireless connection state, and by reading SIB1, recognizes that the cell broadcasts an mIAB cell indicator and a 1-bit indicator indicating to suspend of RNA update. The UE that has received the mIAB cell indicator and the suspending RNAU indicator determines to camp on the cell. Thereafter, the UE compares an RNA list configured for itself with RNA information of the cell transferred in the SIB, and if the RNA of the cell is not included in the list, the UE performs RNA update. In this case, the UE may transmit an RRCResumeRequest message to the cell by using an RACH. The donor CU of the mIAB node may request retrieval of inactive UE context of the UE from a last serving gNB by referring to last serving gNB-related information (e.g., short MAC-I) of the message. The last serving gNB that has received the request may return the inactive UE context of the UE to the donor CU of the mIAB node.

After RNAU of the UE, DU migration may be performed due to movement of the mIAB, a target logical DU cell may be generated as a result thereof, and when a new RNA code is configured for the cell, the inactive UE context of the UE may be transferred between the source donor CU and the target donor CU related to DU migration without RNAU of the UE.

For example, as in FIG. 8, while camping on the stationary cell and then camping on the mIAB source cell, the source donor CU of the mIAB DU, which has retrieved the inactive UE context, may, during or after DU migration, transfer inactive UE context of at least some UEs, for which the source donor CU itself has performed RNAU to the mIAB cell and retrieved the inactive UE context, to the target donor CU. In this case, the source donor CU may use an Xn message.

The mIAB target DU cell may broadcast, via the same PCI as before, new RNA info, the RNAU suspending indicator, and the mIAB cell indicator after the DU migration. This broadcast may be performed via an SIB or SIB1.

If the RNA is changed via the SIB, the UE may recognize the RNA change via a system information update procedure. However, in a state where the RNAU suspending indicator has been previously received, the UE may not perform, in a cell with the same PCI, RNAU caused by the RNA change via the system information update.

That is, when the UE acquires the suspending RNAU indicator and the mIAB cell indicator via the SIB, and camps on a cell that has broadcast the acquired suspending RNAU indicator and mIAB cell indicator, the UE may perform RNAU at the time of camping. However, the UE does not perform RNAU when an RNA code of the camping cell is updated via the system information update.

In addition, when the UE performs cell reselection from the cell on which the UE is currently camping to another cell, the UE may perform RNAU in the reselected cell. For example, if RNA information transmitted by the target cell is not included in the RNA list configured for the UE, the UE performs RNAU.

The contents above may be expressed as in Table 1 below.

TABLE 1

(Case:
mIAB cell's moving only involves RAN area code update, not PCI nor Freq change.
Solution:
mLAB cell broadcast suspending/stop RNAU operation indication in SIBx which
means no RNA U only from next RAN area code change case.
Operation:
When inactive UE reselect to this cell, UE does RNA U first if needed, and pending
RNA U upon system info update (RNA update)
When inactive UE reselect to the other cell (mIAB or stationary cell), follow normal
procedure.
Assessment:
from other stationary cell to mIAB cell: no problem
From mIAB cell to the same mIAB cell: no problem
From mIAB cell to other mIAB cell: no problem
From mIAB cell to other stationary cell: no problem
)

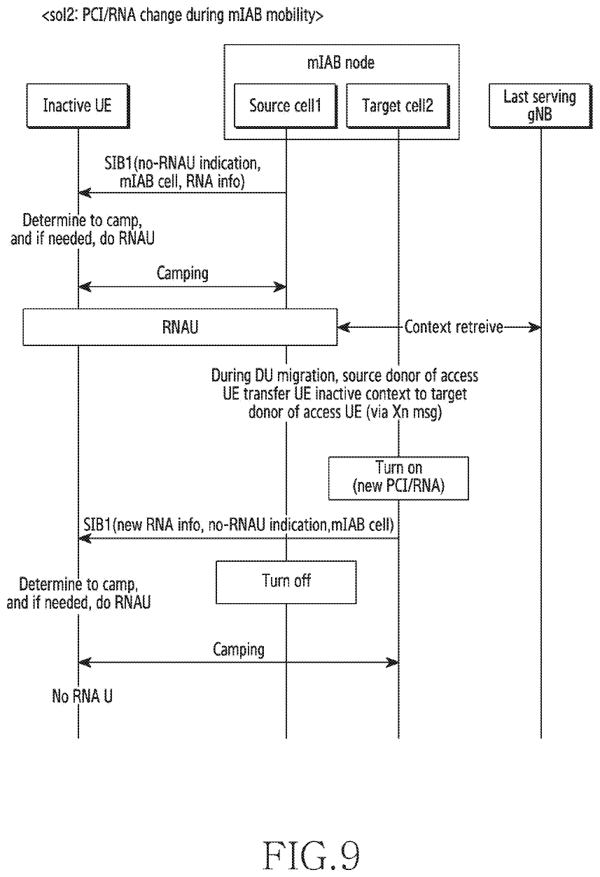

FIG. 9 illustrates a process related to DU migration of an mIAB according to an embodiment of the disclosure. Specifically, FIG. 9 illustrates a process of a case in which DU migration of an mIAB always involves a cell change.

FIG. 9 illustrates a case in which, during DU migration of an mIAB node, a donor CU is changed, and while a PCI and a cell frequency are the same as those of a cell configured by an existing source donor CU, an RNA is changed. A UE that has camped on a previous stationary cell may camp on a source logical DU cell of a DU of the mIAB node.

In this procedure, the UE performs cell reselection, selects the source logical DU cell of the mIAB node by considering a wireless connection state, and by reading SIB1, recognizes that the cell broadcasts an mIAB cell indicator and a 1-bit indicator indicating to suspend (or not to perform) RNA update. The UE that has received the mIAB cell indicator and the suspending RNAU indicator determines to camp on the cell. Thereafter, the UE compares an RNA list configured for itself with RNA information of the cell transferred in the SIB, and if the RNA of the cell is not included in the list, the UE performs RNA update. In this case, the UE may transmit an RRCResumeRequest message to the cell by using an RACH. The donor CU of the mIAB node may request retrieval of inactive UE context of the UE from a last serving gNB by referring to last serving gNB-related information (e.g., short MAC-I) of the message. The last serving gNB that has received the request may return the inactive UE context of the UE to the donor CU of the mIAB node.

After RNAU of the UE, DU migration may be performed due to movement of the mIAB, a target logical DU cell may be generated as a result thereof, and when a new RNA code is configured for the cell, the inactive UE context of the UE may be transferred between the source donor CU and the target donor CU related to DU migration without RNAU of the UE.

For example, as in FIG. 9, while camping on the stationary cell and then camping on the mIAB source cell, the source donor CU of the mIAB DU, which has retrieved the inactive UE context, may, during or after DU migration, transfer inactive UE context of at least some UEs, for which the source donor CU itself has performed RNAU to the mIAB cell and retrieved the inactive UE context, to the target donor CU. In this case, the source donor CU may use an Xn message.

The target logical DU may start cell operation using a new PCI and RNA info, and the new PCI and RNA info may be broadcast as system information. Thereafter, the source logical DU may turn off the existing cell, so that the UE may perform cell reselection to the target cell. When the SIB received by the UE includes the suspending RNAU indicator and also includes the mIAB cell indicator, the UE does not perform RNAU.

That is, when the UE has performed cell reselection from the stationary cell (cell where no mIAB cell indicator is broadcast) to the mIAB cell, the UE may determine to camp on the corresponding cell, and then, when the SIB broadcast from the cell includes the mIAB cell indicator and the suspending RNAU indicator, the UE may perform RNAU as needed. Although the UE performs reselection from the corresponding cell to another mIAB cell in the future, if the corresponding mIAB cell is a cell that broadcasts the suspending RNAU indicator and the mIAB cell indicator, the UE does not perform RNAU. In this case, the expression “as needed” may be understood as indicating that, similar to existing RNAU execution conditions, if the RNA info broadcast by the cell is not included in the RNA list held by the UE, the UE may perform RNAU.

Subsequently, until the UE reselects and camps on a stationary cell (cell where no mIAB cell indicator is broadcast) again, the UE does not perform RNAU during cell reselection within mIAB.

In an embodiment, when the UE is RRC-released to an inactive state, an RRCrelease with suspendConfig field or an RRCRelease message may include an indicator indicating not to perform RNAU when the UE reselects and camps on an mIAB cell. The UE that has received the message and transitioned to the inactive state may not perform RNAU when the UE reselects and camps on an mIAB cell.

In an embodiment, instead of the suspending RNA indicator, non-transmission of RNA code or RNA info in SIB1 itself may replace the suspending RNA indicator. The UE having recognized that no RNA info exists in SIB1 may not perform RNAU regardless of the RNA update execution conditions in FIGS. 8 and 9.

In FIGS. 8 and 9, inactive UE context information of the UE transferred from the source donor CU of the DU to the target donor CU via the Xn message may include the following information. The information in Table 2 below is UE-specific information.

TABLE 2

| | |
|---|---|
| “ | New NG-RAN node UE XnAP ID reference |
| | Old NG-RAN node UE XnAP ID reference |
| | GUAMI |
| | UE Context Information - Retrieve UE Context Response |
| | Trace Activation |
| | Masked IMEISV |
| | Location Reporting Information |
| | Criticality Diagnostics |
| | NR V2X Services Authorized |
| | LTE V2X Services Authorized |
| | PC5 QoS Parameters |
| | UE History Information |
| | UE History Information from the UE |
| | Management Based MDT PLMN List |

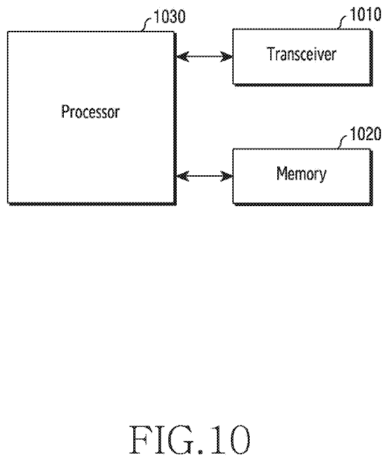

FIG. 10 is a block diagram illustrating an example of a structure of a UE according to an embodiment of the disclosure.

As illustrated in FIG. 10, the UE of the disclosure may include a processor 1030, a transceiver 1010, and a memory 1020. However, components of the UE are not limited to the above-described example. For example, the UE may include a larger or smaller number of components than the above-described components. In addition, the processor 1030, the transceiver 1010, and the memory 1020 may be implemented in the form of a single chip.

According to an embodiment, the processor 1030 may control a series of processes so that the UE can operate according to the above-described embodiments of the disclosure. For example, according to an embodiment of the disclosure, the processor 1030 may control the components of the UE to perform the transmission and reception method of the UE according to whether the base station mode is a base station energy saving mode or a base station normal mode. The processor 1030 may include one or multiple processors, and the processor 1030 may execute programs stored in the memory 1020 to perform transmission and reception operations of the UE in a wireless communication system employing the above-described carrier aggregation of the disclosure.

The transceiver 1010 may transmit/receive signals with base stations. The signals transmitted/received with base stations may include control information and data. The transceiver 1010 may include an RF transmitter configured to up-convert and amplify the frequency of transmitted signals, an RF receiver configured to low-noise-amplify received signals and down-convert the frequency thereof, and the like. However, this is only an embodiment of the transceiver 1010, and the components of the transceiver 1010 are not limited to the RF transmitter and the RF receiver. In addition, the transceiver 1010 may receive signals through a radio channel, output the same to the processor 1030, and transmit signals output from the processor 1030 through the radio channel.

According to an embodiment, the memory 1020 may store programs and data necessary for the operation of the UE. In addition, the memory 1020 may store control information or data included in signals transmitted/received by the UE. The memory 1020 may include storage media such as a ROM, a RAM, a hard disk, a CD-ROM, and a DVD, or a combination of storage media. In addition, the memory 1020 may include multiple memories. According to an embodiment, the memory 1020 may store programs for performing the transmission and reception operations of the UE according to whether the base station mode in the above-described embodiments of the disclosure is a base station energy saving mode or a base station normal mode.

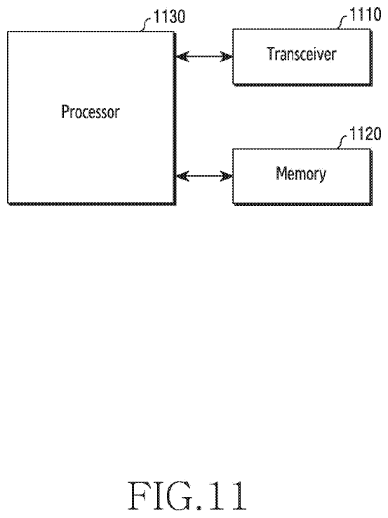

FIG. 11 is a block diagram illustrating an example of a structure of a base station according to an embodiment of the disclosure.

As illustrated in FIG. 11, the base station of the disclosure may include a processor 1130, a transceiver 1110, and a memory 1120. However, components of the base station are not limited to the above-described example. For example, the base station may include a larger or smaller number of components than the above-described components. In addition, the processor 1130, the transceiver 1110, and the memory 1120 may be implemented in the form of a single chip.

The processor 1130 may control a series of processes such that the base station can operate according to the above-described embodiments of the disclosure. For example, according to an embodiment of the disclosure, the processor 1130 may control the components of the base station to perform the UE scheduling method according to whether the base station mode is a base station energy saving mode or a base station normal mode. The processor 1130 may include one or multiple processors, and the processor 1120 may execute programs stored in the memory 1120 to thereby perform the method for scheduling the UE according to whether the above-described base station mode is a base station energy saving mode or a base station normal mode.

The transceiver 1110 may transmit/receive signals with UEs. The signals transmitted/received with UEs may include control information and data. The transceiver 1110 may include an RF transmitter configured to up-convert and amplify the frequency of transmitted signals, an RF receiver configured to low-noise-amplify received signals and down-convert the frequency thereof, and the like. However, this is only an embodiment of the transceiver 1110, and the components of the transceiver 1110 are not limited to the RF transmitter and the RF receiver. In addition, the transceiver 1110 may receive signals through a radio channel, output the same to the processor 1130, and transmit signals output from the processor 1130 through the radio channel.

According to an embodiment, the memory 1120 may store programs and data necessary for the operation of the base station. In addition, the memory 1120 may store control information or data included in signals transmitted/received by the base station. The memory 1120 may include storage media such as a ROM, a RAM, a hard disk, a CD-ROM, and a DVD, or a combination of storage media. In addition, the memory 1120 may include multiple memories. According to an embodiment, the memory 1120 may store programs for performing the method for scheduling the UE according to whether the base station mode in the above-described embodiments of the disclosure is a base station energy saving mode or a base station normal mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a user equipment (UE) in a wireless communication system, the method comprising:
receiving, from a mobile integrated access and backhaul (mIAB) node configured to provide a first cell, first system information including a radio access network (RAN)-based notification area (RNA) update suspension indicator and first RNA information;
camping on the first cell;
performing a first RNA update, based on the first RNA information; and
receiving, from the mIAB node configured to provide a second cell, second system information including second RNA information,
wherein, based receiving the RNA update suspension indicator, a second RNA update based on the second RNA information is not performed.

17. The method of claim 16, wherein the first system information further includes a first cell identifier,
wherein the second system information further includes a second cell identifier, and
wherein the first cell identifier and the second cell identifier are identical.

18. The method of claim 16, wherein the first system information further includes a first cell identifier,
wherein the second system information further includes a second cell identifier, and
wherein the first cell identifier and the second cell identifier are different.

19. The method of claim 16, further comprising transmitting, to the mIAB node, a radio resource control (RRC) resume request message,
wherein the RRC resume request message includes previous serving base station-related information of the UE, and
wherein a first donor central unit (CU) for the first cell receives an inactive UE context of the UE from a previous serving base station, based on the previous serving base station-related information.

20. The method of claim 19, wherein the first donor CU transfers the inactive UE context to a second donor CU for the second cell.

21. A method performed by a mobile integrated access and backhaul (mIAB) node in a wireless communication system, the method comprising:
transmitting, to a user equipment (UE), via a first cell, first system information including first radio access network (RAN)-based notification area (RNA) information and an RNA update suspension indicator;
generating a second cell, based on a movement of the mIAB node; and
transmitting, to the UE, via the second cell, second system information including second RNA information,
wherein a first RNA update is performed based on the first RNA information, and
wherein, based on the UE receiving the RNA update suspension indicator, a second RNA update based on the second RNA information is not performed.

22. The method of claim 21, wherein the first system information further includes a first cell identifier,
wherein the second system information further includes a second cell identifier, and
wherein the first cell identifier and the second cell identifier are identical.

23. The method of claim 21, wherein the first system information further includes a first cell identifier,
wherein the second system information further includes a second cell identifier, and
wherein the first cell identifier and the second cell identifier are different.

24. The method of claim 21, further comprising receiving, from the UE, a radio resource control (RRC) resume request message for the first RNA update,
wherein the RRC resume request message includes previous serving base station-related information of the UE, and
wherein a first donor central unit (CU) for the first cell receives an inactive UE context of the UE from a previous serving base station, based on the previous serving base station-related information.

25. The method of claim 24, wherein the first donor CU transfers the inactive UE context to a second donor CU for the second cell.

26. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a mobile integrated access and backhaul (mIAB) node configured to provide a first cell, first system information including a radio access network (RAN)-based notification area (RNA) update suspension indicator and first RNA information;
camp on the first cell;
perform a first RNA update, based on first RNA information; and
receive, from the mIAB node configured to provide a second cell, second system information including second RNA information,
wherein, based on receiving the RNA update suspension indicator, a second RNA update based on the second RNA information is not performed.

27. The UE of claim 26, wherein the first system information further includes a first cell identifier,
wherein the second system information further includes a second cell identifier, and
wherein the first cell identifier and the second cell identifier are identical.

28. The UE of claim 26, wherein the first system information further includes a first cell identifier,
wherein the second system information further includes a second cell identifier, and
wherein the first cell identifier and the second cell identifier are different.

29. The UE of claim 26, wherein the instructions further cause the UE to transmit, to the mIAB node, a radio resource control (RRC) resume request message,
wherein the RRC resume request message includes previous serving base station-related information of the UE, and
wherein a first donor central unit (CU) for the first cell receives an inactive UE context of the UE from a previous serving base station, based on the previous serving base station-related information.

30. The UE of claim 29, wherein the first donor CU transfers the inactive UE context to a second donor CU for the second cell.

31. A mobile integrated access and backhaul (mIAB) node comprising:
at least one transceiver;
at least one processor communicatively coupled to the at least one transceiver; and
at least one memory, communicatively coupled to the at least one processor, storing instructions executable by the at least one processor individually or in any combination to cause the mIAB node to:
transmit, to a user equipment (UE) via a first cell, first system information comprising first RAN-based notification area (RNA) information and an RNA update suspension indicator;
generate a second cell, based on a movement of the mIAB node; and
transmit, to the UE via the second cell, second system information comprising second RNA information,
wherein a first RNA update is performed based on the first RNA information, and
wherein, based on reception of the RNA update suspension, a second RNA update based on the second RNA information is not performed

32. The mIAB node of claim 31, wherein the first system information further includes a first cell identifier,
wherein the second system information further includes a second cell identifier, and
wherein the first cell identifier and the second cell identifier are identical.

33. The mIAB node of claim 31, wherein the first system information further includes a first cell identifier,
wherein the second system information further includes a second cell identifier, and
wherein the first cell identifier and the second cell identifier are different.

34. The mIAB node of claim 31, wherein the instructions further cause the mIAB node to receive, from the UE, a radio resource control (RRC) resume request message for the first RNA update,
wherein the RRC resume request message includes previous serving base station-related information of the UE, and
wherein a first donor central unit (CU) for the first cell receives an inactive UE context of the UE from a previous serving base station, based on the previous serving base station-related information.

35. The mIAB node of claim 34, wherein the first donor CU transfers the inactive UE context to a second donor CU for the second cell.
